(19) United States
(12) Patent Application Publication
(10) Pub. No.: US 2006/0250583 A1
(43) Pub. Date: Nov. 9, 2006

(54) Multi-mode projectors with spatial light modulators

(76) Inventors: Andrew Huibers, Palo Alto, CA (US); Robert Duboc, Menlo Park, CA (US)

Correspondence Address: TEXAS INSTRUMENTS INCORPORATED, P O BOX 655474, M/S 3999, DALLAS, TX, 75265, US

(21) Appl. No.: 11/169,990

(22) Filed: Jun. 28, 2005

Related U.S. Application Data
(60) Provisional application No. 60/678,617, filed on May 5, 2005.

(51) Int. Cl. G03B 21/26

(52) U.S. Cl. 353/30

(57) ABSTRACT

Disclosed herein is a projection system that comprises an enhanced projection mode and regular mode. In the enhanced mode, media contents are displayed such that the perceived resolution is higher than the native resolution of the light valve. In the regular mode, media contents are projected with a resolution of the naïve resolution of the light valve. Viewers can operate the projection system in either of the two modes based upon the property of the media content or the viewers' preferences, or both.

### CROSS-REFERENCE TO RELATED ARTS

The subject matter of the provisional U.S. patent application Ser. No. 60/678,617 filed May 5, 2005; and U.S. patent applications US20040027313, US20050025388, and US20050093894; and U.S. Pat. Nos. 6,317,169 and 5,402,184, are incorporated herein by reference in entirety.

### TECHNICAL FIELD OF THE INVENTION

The present invention is generally related to the art of projection systems, and more particularly, to method of projecting images from light valves having individually addressable pixels.

### BACKGROUND OF THE INVENTION

In projection systems that utilize light valves, images are produced by modulating incident light beams with individually addressable pixels of the light valves. The number of addressable pixels in a light valve predominately determines the resolution of the projected images. Specifically, the more addressable pixels a light valve has, the higher resolution the projected images can be. However, the number of addressable pixels in a single light valve is subject to many limitations in both manufacturing and factors from other components of the light valve. Increasing the image resolution by enlarging the number of addressable pixels increases the cost and complexity of the pixels in the light valve.

Therefore, what is needed is a method of projecting images of higher perceived resolutions from a light valve with less addressable pixels.

### SUMMARY OF THE INVENTION

In view of foregoing, multi-mode projectors with light valves are disclosed. The projectors are capable of projecting images with an enhanced mode and a regular mode. In the enhanced projection mode, images are produced such that the perceived resolution of the produced images is higher than the number of active addressable pixels in the light valve. This can be accomplished by scanning the image area at a display target with the modulated light beams from the active pixels of an array of addressable pixels. In projecting a video having a sequence of frames, different portions of the each video frame are projected on different locations at the display target. The scanning speed is above a threshold such that the viewer's eyes meld two or more image pixels in the image area generated from each addressable pixel, and perceive a higher resolution than the natural resolution of the light valve. In the regular mode, images are produced by the active pixels of the light valve with the perceived resolution equal to the number of the active pixels.

The enhanced mode and regular mode are selected in a particular display application by the viewer. The viewer can force the projector to operate in the enhanced mode or regular mode, for example at any time during the projection, and regardless of the current operation mode. The viewer may also select the mode through a programmable menu of the projector. The programmable menu can be a functional part of the system setting function of the projector, wherein the system setting is an interface that integrates the functional modules of the projection system and the user instructions in the projection operation.

In the system setting, the user can set the projection system to either automatically determine in which mode to operate or manually select the mode. If the manual mode is selected, the projection system waits for the user to determine in which mode to operate the projection system according to, for example, user's preferences and the content to be projected. If the automatic determination is selected, the projection system can determine the mode based upon the content to be displayed, or can actively determine the operation mode. The active determination can be made by sampling the content to be displayed in both modes; evaluating the qualities of the samples; and comparing the evaluated qualities. The mode in which the produced sample has a better quality is selected as the operation mode for projecting the content that is sampled. Obviously, such decisions can be changed over time for different content to be displayed. Of course, the mode can be determined based on other factors.

In an exemplary implementation, the invention is implemented in a multi-mode projection system having one or more light valves each of which comprises an array of micromirrors. The micromirror array may comprise an active area and an inactive area. The micromirrors in the active area each being associated with a pixel of the content to be displayed in a display target, and being operated between an ON and OFF state based upon the image data (e.g. bitplane data) of the content to be displayed. The micromirrors in the inactive area are operated independent from the content to be displayed.

The projection system may comprise a physical button or switch by which the projection system can be forced to operate in the enhanced mode or regular mode. Such button or switch can be deployed on the box enclosing the components of the projection system. The mode selection through the system setting can be accomplished using the buttons or keys associated with the system setting.

Alternatively, a remote controlling mechanism can be employed to enable the user to remotely select the mode. The remote controller comprises a wireless transmitter and wireless receiver. The wireless transmitter transmits the viewer's selection to the wireless receiver in the projection system. The mode selection instruction can be integrated with other instruction signals generated by other functional modules of the wireless transmitter. Upon the receipt of the signals integrated with the mode selection instruction, the wireless receiver extracts the mode selection instruction from other signals, and dispatches the extracted mode selection signals and other signals to the corresponding functional modules of the projection system.

The objects and advantages of the present invention will be obvious, and in part appear hereafter and are accomplished by the present invention. Such objects of the invention are achieved in the features of the independent claims attached hereto. Preferred embodiments are characterized in the dependent claims.

### BRIEF DESCRIPTION OF THE DRAWINGS

The accompanying drawings are illustrative and are not to scale. In addition, some elements are omitted from the drawings to more clearly illustrate the embodiments. While the appended claims set forth the features of the present invention with particularity, the invention, together with its objects and advantages, may be best understood from the following detailed description taken in conjunction with the accompanying drawings, in which:

FIG. 1 is a diagram schematically illustrates an exemplary projection system in which embodiments of the invention can be implemented;

FIG. 2 is a diagram showing the illumination system of the projection system of FIG. 1;

FIG. 3 is an exemplary light valve having an array of deflectable micromirror devices usable in the projection system in FIG. 1;

FIG. 4 is an exemplary micromirror device of FIG. 3;

FIG. 5 is a diagram showing the logic of selecting a mode from the multi-modes to operate the projection system;

FIG. 6 is a diagram demonstrates an exemplary method of projecting the modulated light onto the display target so as to obtain a perceived resolution higher than the total number of the active pixels in the light valve;

FIG. 7 demonstrates different positions of the image pixels generated by the method demonstrated in FIG. 5;

FIG. 8 illustrates the pixel array of the light valve having two different areas corresponding to different operation modes according to an embodiment of the invention;

FIG. 9 illustrates another light valve operable in multi-modes according to another embodiment of the invention;

FIG. 10 illustrates the pixel array of the light valve having two different areas corresponding to different operation modes according to yet another embodiment of the invention;

FIG. 11 illustrates another light valve operable in multi-modes according to another embodiment of the invention;

FIG. 12 demonstratively illustrates a layout of a projection system; and

FIG. 13 schematically demonstrates another exemplary projection system in which embodiments of the invention can be implemented.

### DETAILED DESCRIPTION OF THE DRAWINGS

The present invention will be discussed in the following with reference to examples wherein the reflective valve comprises an array of deflectable reflective micromirrors. However, it will be understood that the following discussion is for demonstration purposes, and should not be interpreted as a limitation. Instead, any variations without departing from the spirit of the invention are applicable. For example, the invention is also applicable to other types of light valves, such as liquid crystal on silicon devices or transmissive light valves, such as liquid crystal devices.

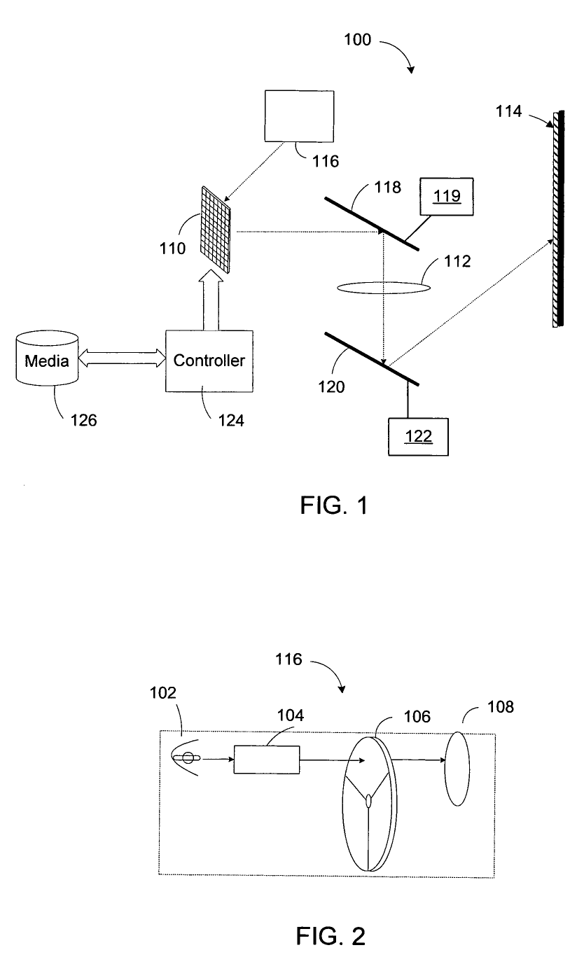

Turning to the drawings, FIG. 1 illustrates an exemplary projection system in which embodiments of the invention can be implemented. Display system 100 comprises illumination system 116 providing light beams to illuminate light valve 110. Light valve 110 comprises an array of active pixels, such as liquid crystal on silicon cells, or transmissive liquid crystal cells or micromirror devices. The pixels of the light valve modulate the incident light beams according to image data (such as bitplane data) that are derived from the desired images and video signals. The modulated light beams are then reflected by mirror 118 that reflects the modulated light beams to another mirror 120 through projection lens 112. The light beams reflected from mirror 120 are then projected to display target 114 so as to generate a pixel pattern.

An exemplary illumination system 116 is illustrated in FIG. 2. Referring to FIG. 2, the illumination system comprises light source 102, light pipe 104, color wheel 106, and condensing lens 108. The light source can be an arc lamp with an elliptical reflector. The arc lamp may also be the arc lamps with retro-reflectors, such as Philips BAMI arc lamps. Alternatively, the arc lamp can be arc lamps using Wavien reflector systems each having a double parabola. The light source can also be one or multiple LEDs or lasers or an electrodeless arc lamp.

The color wheel comprises a set of color segments, such as red, green, and blue, or may include cyan, yellow, or magenta. A white or clear or other color segments can also be provided for the color wheel. In the operation, the color wheel spins such that the color segments sequentially pass through the illumination light from the light source and generates sequential colors to be illuminated on the light valve. For example, the color wheel can be rotated at a speed of at least 4 times the frame rate of the image data sent to the light valve. The color wheel can also be rotated at a speed of 240 Hz or more, such as 300 Hz or more.

The lightpipe is provided for delivering the light from the light source to the color wheel and, also for adjusting the spatial distribution of the illumination light from the light source as appropriate. As an alternative feature, a set of fly's eye lenses can be provided to alter the cross section of the light from the light source.

Condensing lens 108 may have a different f-number than the f-number of projection lens 112 in FIG. 1. In this particular example, the color wheel is positioned after the light pipe along the propagation path of the light beams. In another embodiment, the color wheel can be positioned between the lightpipe and light source, which is not shown in the figure.

According to the invention, mirror 118 or mirror 120 or both are movable. For example, mirror 118 can be rotated in the plane of the paper along a rotation axis that points out from the paper. Such rotation can be driven accomplished by a micro-actuator 119 (e.g. a piezo-actuator) connected to mirror 118. Similarly, mirror 120, if necessary, can be connected to micro-actuator 122 for rotating mirror 120.

By rotating mirror 118 or mirror 120 or both, the pixel patterns generated by the pixels of the light valve according to the image data can be moved spatially across the image area (the area where the desired images and videos are projected) at the display target so as to obtain the projected images and videos with a higher resolution than the total number of pixels of the light valve used in modulating the incident light beams.

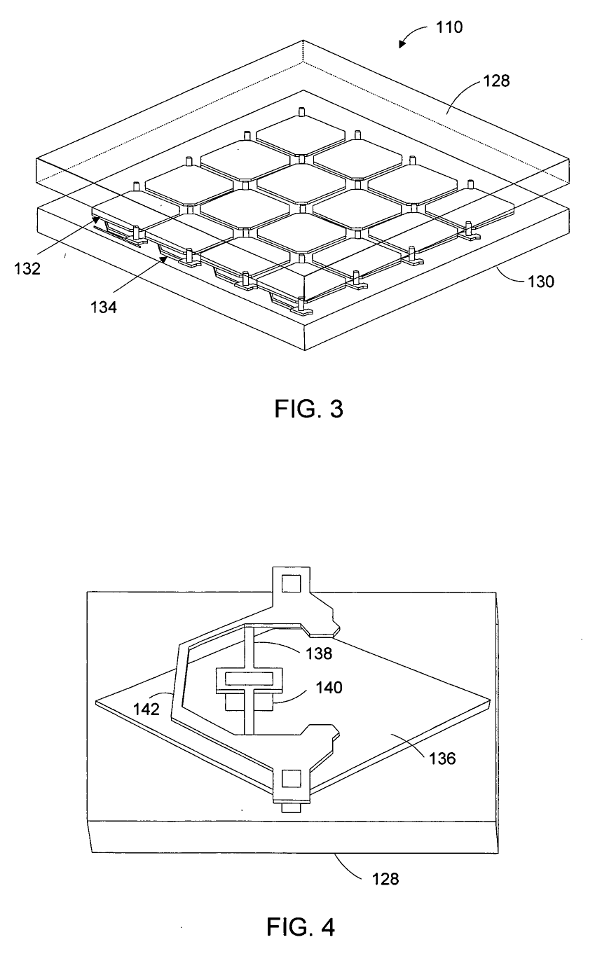

An exemplary light valve in the projection system in FIG. 1 is demonstratively illustrated in FIG. 3. For simplicity purposes, only 4×4 micromirror devices of the light valve are show. In general, the micromirror device array of the light valve may comprise any suitable number of reflective deflectable micromirror devices, such as 512×384 or higher, 960×540 or higher, 1024×768 or higher, and 1920×1080. The aspect ratio (the ratio of the number of rows to number of columns in the array) can be standard 4:3 or 16:9 or any desired ratios.

Light valve 110 comprises an array of reflective deflectable mirror plates 132 disposed between light transmissive substrate 128 and semiconductor substrate 130. Each mirror plate of the micromirror device array is associated with an addressing electrode of an array of addressing electrodes 134 for electrostatically deflecting the mirror plate. In operation, the incident light beams passes through the light transmissive substrate and impinge the reflective surfaces of the mirror plates. By deflecting the mirror plates to different rotation positions (e.g. the ON and OFF state), the incident light beams are reflected either onto or away from the projection lens (e.g. projection lens 112 in FIG. 1). The light beams reflected onto the projection lens results in a “bright” image pixel on the display target, while the light beams reflected away from the projection lens result in a “dark” pixel on the display target.

In an embodiment of the invention, the micromirrors are square in shape. The squared micromirrors are deployed in the light valve such that the edges of the micromirrors are aligned in straight lines forming an orthogonal lattice. The straight lines of the micromirror edges can be parallel to the edges of the micromirror device array, or alternatively parallel to the edges of the light valve.

The micromirror device of the light valve in FIG. 3 is better illustrated in FIG. 4. Referring to FIG. 4, mirror plate 136 is attached to deformable hinge 138 via hinge contact 140 such that the mirror plate and deformable hinge are located in different planes when the mirror plate is not deflected. The deformable hinge is held by hinge support 142 that is affixed to and thus held by the post formed on light transmissive substrate 128.

The micromirror device and micromirror array device in FIG. 3 and FIG. 4 are only examples of many applicable micromirror devices and micromirror array devices. In another example, the mirror plates can be formed on the same substrate as the addressing electrodes, such as on semiconductor substrate 130. In this instance, a light transmissive substrate may not be required. For obtaining a higher contrast ratio by separating the reflected light from the ON and OFF state as far away as possible, the mirror plate can be attached to the deformable hinge at an attachment point away from the mass center of the mirror plate such that the mirror plate rotates asymmetrically in opposite directions, as shown in FIG. 4. Alternatively, the mirror plate can be attached to the deformable hinge at an attachment point substantially at the mass center of the mirror plate such that the mirror plate rotates symmetrically.

In other embodiments, the mirror plate can be formed in the same plane as the deformable hinge. In particular, the mirror plate and deformable hinge can be derived from the same material, such as a single crystal material.

Each mirror plate in the above example is preferably associated with one single addressing electrode for electrostatically deflecting the mirror plate. Alternatively, each mirror plate can be associated with multiple addressing electrodes for electrostatically deflecting the mirror plate in multiple rotation directions.

The micromirror device can be fabricated with a typical dimension (e.g. the diameter of the mirror plate) of 50 microns or less, preferably 20 microns or less, or 15 microns or less, or 10 microns or less. In the micromirror device array, the center-to-center distance between the adjacent mirror plates can be 10.16 microns or less, such as 4.38 to 10.16 microns. The nearest distance between the edges of the mirror plate can be from 0.1 to 1.5 microns, such as from 0.15 to 0.45 micron, as set forth in U.S. patent application Ser. No. 10/627,302, Ser. No. 10/627,155, and Ser. No. 10/627,303, both to Patel, filed Jul. 24, 2003, the subject matter of each being incorporated herein by reference.

The micromirror device may have other features, such as stopping mechanisms for limiting the rotation of the mirror plate, by which the ON and/or OFF states can be defined; optical coatings on the light transmissive substrate such as an anti-reflection film and transparent electrode for deflecting the mirror plate towards such transparent electrode, and light blocking/absorbing materials for avoiding unwanted light scattering from other components of the micromirror device.

Turning back to FIG. 1, the pixels of the light valve reflects the incident light beams so as to produce the desired media content on the display target. The reflections of the light valve pixels are controlled by controller 124. In operation, the controller retrieves the media data derived from the media content (e.g. the desired images and videos) from media database 126, and delivers the retrieved media data to the pixels of the light valve. The light valve pixels are deflected to the ON or OFF states individually based on the media data, as set forth in U.S. patent application Ser. No. 10/648,608 filed Aug. 25, 2003, and U.S. patent application Ser. No. 10/648,689 filed Aug. 25, 2005, U.S. patent application Ser. No. 10/698,290 filed Oct. 23, 2003, the subject matter of each being incorporated herein by reference.

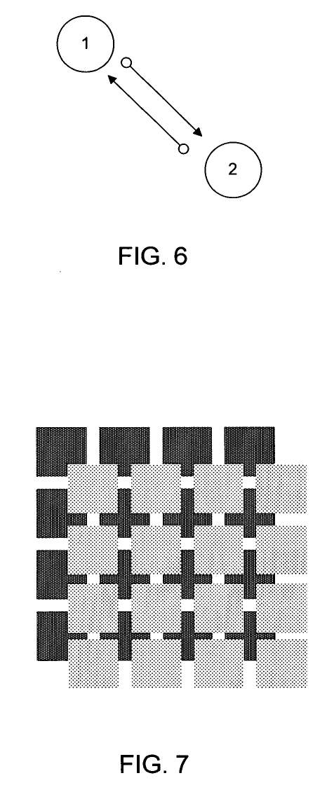

According to the invention, the projection system is capable of operating in multiple modes that comprise an enhanced mode and regular mode for different media content to be projected. In the enhanced mode, the media content is projected such that the perceived resolution is higher than the total number of the active light valve pixels used in generating the media content, which will be discussed afterwards with reference to FIG. 6 and FIG. 7. In the regular mode, the perceived resolution is equal to or less than the total number of the active light valve pixels used in generating the media content. Either mode can be used to display animated media content, such as sports, movies, and video games, and static images, such as presentations, and text documents. The enhanced mode increases the perceived resolution; however, it may introduce unwanted perceivable artifacts. The regular mode, even though can not produce a higher perceived resolution as provided in the enhanced mode; it does not introduce the artifacts that might be introduced by the enhanced mode. This dilemma is solved by providing both modes to the display system, and giving the viewer the opportunity to decide in which mode to operate the projection system. In an alternative embodiment, multiple modes (e.g. where light beams reflected from a pixel of the light valve is projected on two or more positioned at the display target) of different perceived resolutions can be employed.

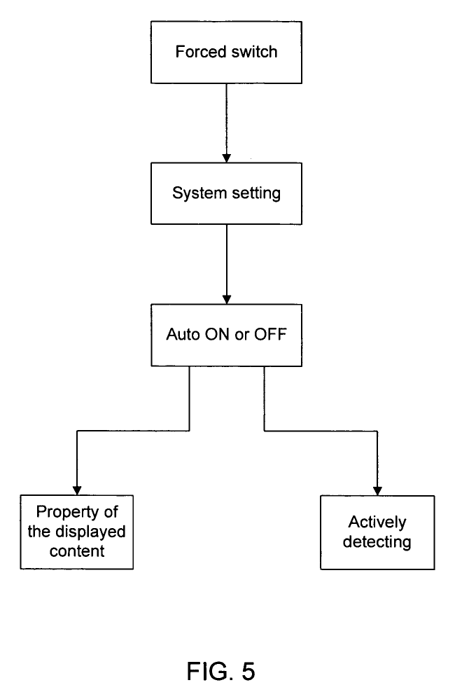

As an aspect of the embodiment of the invention, the viewer can force the projection system to operate in either one of the modes for particular media content in a projection. The viewer can also instruct the projection system to perform an automatic decision based on the property of the media content to be projected or the practical visual effect of the media content to be projected, or the viewer's personal preferences. A logic diagram showing the methods in selecting the operation mode is illustrated in FIG. 5.

Referring to FIG. 5, the viewer can force the projection system to operate in the enhanced mode or regular mode. If the viewer does so, the system operates in the viewer determined mode regardless of the other system settings until the viewer de-activates such instruction. The viewer can allow the projection system to automatically determine in which mode to operate the projection system through the system setting.

The system setting can be accomplished through a system setting menu that integrates the mode selection and other operation instructions (if any) and delivers the selection and instructions to the corresponding functional modulus of the projection system. When the viewer selects the system to automatically select between the regular mode and enhanced mode, another selection can be performed between determining the mode based upon the property of the media content and determining the mode based upon the practical visual effects. When it is instructed by the viewer to automatically select the mode based upon the property of the media content, the projection system detects the property of the media content, and operates in the mode associated with the properties of the media content. For example, the system can determine the property of the media content by the suffix, such as .txt, .doc, .asf, .wma, .wmv, .avi, .wav, .mpeg, .mp3, mid, .aiff, .au, and .rm etc. The projection system can also detect the property of the media content based on the information carried with the media content. When a static media content, such as a power point presentation, a text document (e.g. a word document), or a static photo and other non-animated media content, the system may select the regular mode to produce the media content. When an animated media-content, such as video streams, video games, sport shows, movies or other animated media contents, is detected, the projection system may operate in the enhanced mode to producing the media content. Before making the selection between the multi-modes based on the detected properties, media contents of different groups of properties are pre-associated with individual modes. Of course, such association can be re-defined during or after the projection of media contents.

When the viewer instructs the projection system to automatically select between the enhanced mode and regular mode based on the practical visual effect of the media content to be displayed, the system may perform an active inspection. For example, the projection system may sample the media content and quantitatively or non-quantitatively determine the visual effect of the sampled media content projected by either one or both of the enhanced mode and regular mode. The quantitative determination can be performed in aid of empirical information or data, or be performed by other quantitative methods, such as those used in image analyses. When it is determined that the visual effect of the sampled media content projected with one particular mode (e.g. the enhanced mode) is satisfactory (e.g. above a threshold), the media content is then projected with the particular mode (e.g. the enhanced mode). Otherwise, the other mode (e.g. the regular mode is used). Alternatively, the visual effects of the sampled media contents projected in both modes can be compared. The mode in which the projected sampled media content has better quality is selected to project the media content. In another embodiment of the invention, the projection system can select between modes based on the resolution of an input signal.

Some media content may carry hybrid content that comprises both static material (e.g. static images, text, and other non-animated contents) and animated material. To maximize the visual effect of such projected hybrid content, the projection system may dynamically switch between the enhanced mode and regular mode during the projection. Specifically, the static materials can be projected in the regular mode while the animated material of the same media content can be projected in the enhanced mode. Of course, such hybrid media content can be projected in a single mode that can be determined based upon the statistical analyses of the content. For example, if the animated material occupies a portion in the entire content larger than a threshold (e.g. 50% or more), the entire content can be projected with the enhanced mode, and vise visa.

The enhanced mode can be accomplished in many ways, one of which is demonstrated in FIG. 6 and FIG. 7. Referring to FIG. 6, the light beams modulated based on the media content are projected in a first position marked as 1, and second position marked as 2 that is displaced along the diagonal of the pixel array of the light valve. In alternative embodiments, more than two offset positions, such as 3, 4, 5 etc can be visited in a sequence in the time domain at a frequency higher than the human visual system responses to achieve the perceived spatial resolution increase.

FIG. 7 demonstratively illustrates the image pixels during the enhanced operation mode. The pixel array is represented by an array of squares. The dark and light colored squares are the pixels at different locations on the display target. By projecting the modulated light beams on different locations on the display target, the perceived resolution of the projected media content is higher than the total number of the active pixels used of the light valve in producing the media content. For example, an image projected by m×n pixels of the light valve can have a visual resolution of m×n×p if the image pixels generated by the reflected light beams are switched between p positions. In the example shown in FIG. 6 and FIG. 7 wherein the image pixels are switched between two positions, p is 2 (two). Therefore, the visual resolution of the projected media content is doubled. In other embodiments wherein the projected images modes between multiple positions wither discretely or continuously or a combination thereof, the visual resolution can be even higher. Other exemplary switching methods are described in U.S. patents and patent applications US20040027313, US20050025388, US20050093894, U.S. Pat. Nos. 6,317,169, and 5,402,184, the subject matter of each being incorporated herein by reference in entirety. In the enhanced mode, image pixels at the display target can be displaced ⅛ to ⅞, preferably ¼ to ¾, and more preferably around ½ of the length or diagonal of the pixel.

With the projection method as discussed above and other applicable variations thereof, a modulated light beam (i.e. a reflected light beam from a pixel of the light valve at the ON state) is projected in the enhanced mode at multiple different locations at the display target. A larger number of pixels at the display target are addressed than the total number of light valve pixels used in projecting the media content. When the switching frequency of projecting the light beam at multiple locations at the display target is higher than the flicker frequency, human eyes meld the illumination patterns of the multiple locations and perceive the projected media content with a resolution determined by all addressed pixels at the display target.

For the exemplary light valve having an array of micromirror devices as that shown in FIG. 3 wherein the edges of the individual micromirror devices are aligned into straight lines, the edges of the micromirror devices may be observed when the projection system employing the light valve operates in the enhanced mode, depending upon displacement routes of the images of the light valve pixels projected at the display target. For example, when the displacement is made along a diagonal of the light valve pixels, the edges of the individual light valve pixels are projected to multiple locations at the display target, resulting in the less perceivable pixel edges. When the displacement is made along the edges of the light valve pixels, for example, the images of the pixels of the regular pixel array as that shown in FIG. 3 move horizontally or vertically, the edges may still be perceived.

The enhanced mode can be accomplished by rotating either one or both of the reflection mirrors 118 and 120 in FIG. 1, as set forth in U.S. provisional application Ser. No. 60/678,617 filed May 5, 2005, the subject matter being incorporated herein by reference. In other embodiments depending upon the specific configurations of the projectors, optical elements capable of altering the propagation paths of the light beams (e.g. light beams onto or reflected from the pixels of the light valves) can be provided to accomplish the enhanced mode, as those set forth in U.S. patent application publications 20020135729, 20030098945, and 20030222980, the subject matter of each being incorporated herein by reference in entirety. In yet another embodiment of the invention, the light valve (as do the pixels thereof) can be displaced between multiple positions during the operation so as to accomplish the enhanced mode.

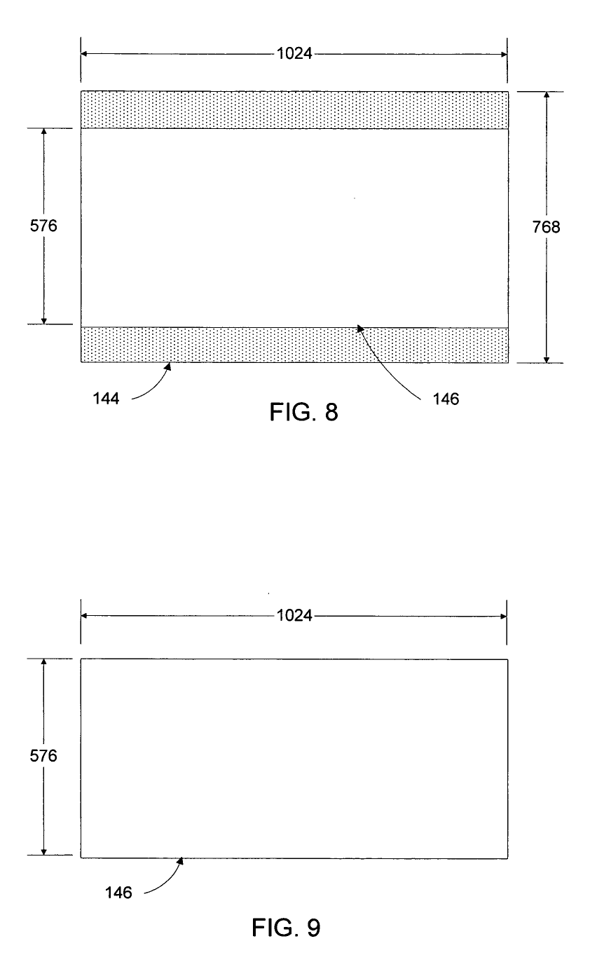

For optimizing the viewing experience, the embodiments of the invention can be incorporated with other modes, such as the modes for projecting media content of different aspect ratios. For example, some of the current media content has a native displayed aspect of 4:3 (referred to as the regular format), while some other media content has a native aspect ratio of 16:9 (referred to as widescreen). To accommodate different media content with multi formats, media content can be projected with different portions of the light valve, which will be discussed in the following with reference to FIG. 8.

Referring to FIG. 8, light valve has pixel array 144 with a native resolution of 1024×768. In the regular projection mode, the total number of the addressable image pixels on the display target is 786432, which is the total number of pixels in the array 144. Sub-array 146 is located within pixel array 144 and has a native resolution of 1024×576. The sub-array can be at the middle of the array 144, or can be at any location. If sub-array 146 is used in producing a media content in the regular mode, the perceived resolution of the produced media content is 589824, which is the total number of pixels in the sub-array. In the enhanced mode as described with reference to FIG. 6 and FIG. 7, the perceived resolution of the produced media content is 1179648, which doubles the native resolution of the sub-array, and is higher than the perceived resolution produced by array 144 in the regular mode.

In accordance with an embodiment of the invention, array 144 is used in the regular mode in a projection application, while sub-array 146 is used in the enhanced mode in a projection application. Alternatively, pixel array 144 can be used to produce media content with a native aspect ratio of 4:3, while pixel array 146 can be used for media content with a native resolution of 16:9.

When sub-array 146 is used, pixels of array 144 outside the sub-array can be de-activated—that is, these pixels are operated independently from the media data derived from the media content. For improving the contrast ratio, the inactive pixels can be set to the OFF state throughout the projection so as to generate a black frame on the display target. Alternatively, a mask corresponding to the inactive pixels can be used to blackout the reflected light traveling onto the display target.

In another embodiment of the invention, either one of the pixel array 144 and sub-array 146 can be used independently, as shown in FIG. 9. Referring to FIG. 9, sub-array 146 in FIG. 8 can be used for both of the enhanced mode and regular mode. Moreover, sub-array 146 can be used for projecting media contents of multiple formats, such as the 4:3 format and 16:9 format.

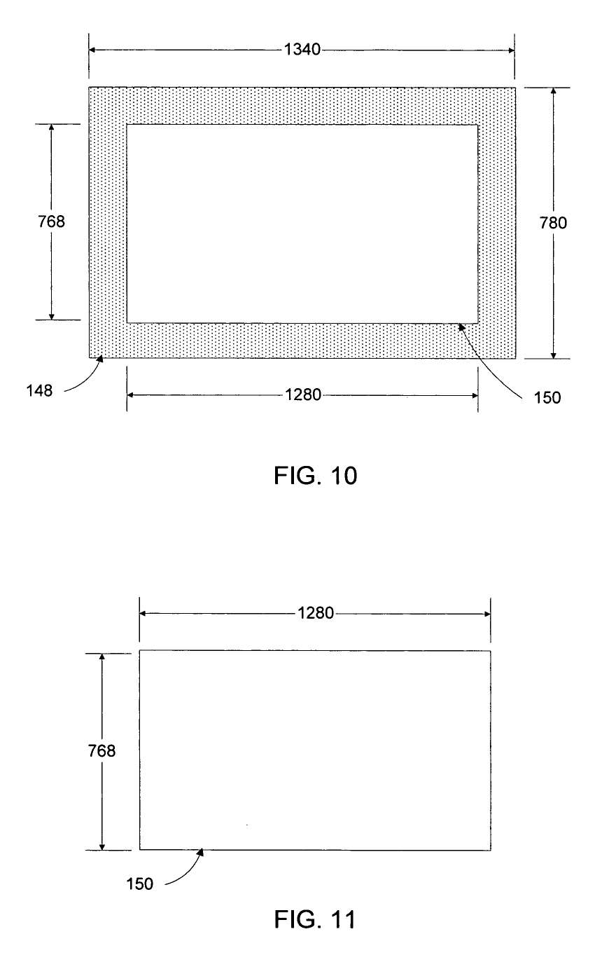

FIG. 10 demonstratively illustrates another light valve usable for multi-modes and multi-formats. Pixel array 148 has with a native resolution of 1340×780. In the regular projection mode, the total number of the addressable image pixels on the display target is 1045200, which is the total number of pixels in the array 148. Sub-array 150 is located within pixel array 148 and has a native resolution of 1280×768. The sub-array can be at the middle of the array 148, or can be at any locations. If sub-array 150 is used in producing a media content in the regular mode, the perceived resolution of the produced media content is 983040, which is the total number of pixels in the sub-array. In the enhanced mode as described with reference to FIG. 6 and FIG. 7, the perceived resolution of the produced media content by sub-array 150 is 1966080, which doubles the native resolution of sub-array 150, and higher than the perceived resolution produced by array 148 in the regular mode.

In accordance with the embodiment of the invention, array 148 is used in the regular mode in a projection application, while sub-array 150 is used in the enhanced mode in a projection application. Alternatively, pixel array 148 can be used to produce media contents with a native aspect ratio of 4:3, while pixel array 150 can be used for media contents with a native resolution of 16:9.

When sub-array 150 is used, pixels of array 148 outside the sub-array can be de-activated—that is, these pixels are operated independent from the media data derived from the media content. For improving the contrast ratio, the inactive pixels can be set to the OFF state throughout the projection so as to generate a black frame on the display target. Alternatively, a mask corresponding to the inactive pixels can be used to blackout the reflected light traveling onto the display target.

In another embodiment of the invention, either one of the pixel array 148 and sub-array 150 can be used independently, as shown in FIG. 10. Referring to FIG. 10, sub-array 150 in FIG. 10 can be used for both of the enhanced mode and regular mode. Moreover, sub-array 150 can be used for projecting media contents of multiple formats, such as the 4:3 format and 16:9 format.

In yet another embodiment of the invention, array 148 in FIG. 10 can be used in the regular mode or enhanced mode or both. In the regular mode, the perceived resolution of the projected image is 1045200, while in the enhanced mode as descried with reference to FIG. 6 and FIG. 7, the perceived resolution is 2090400. Array 148 can also be employed in projecting images with different aspect ratios, in which instance, some pixels may be de-activated or masked.

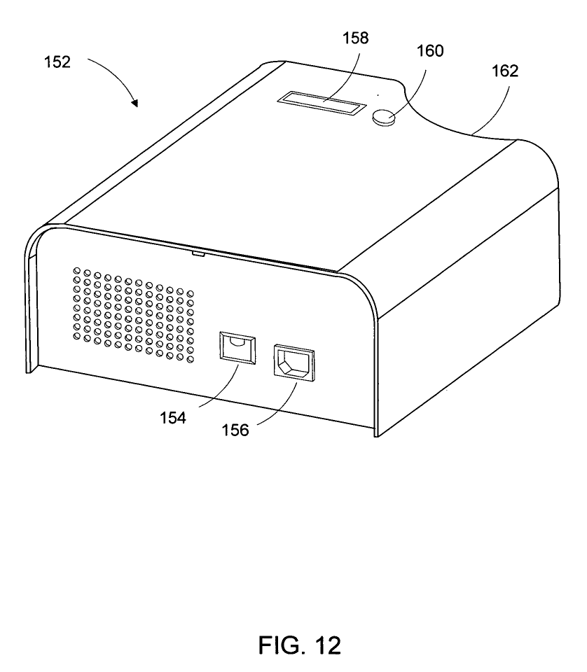

Selections of between the regular projection mode and enhanced projection mode, as well as the formats can be made through buttons deployed on the cover box of the projection system, an example of which is demonstratively illustrated in FIG. 12. Referring to FIG. 12, projection system 152 comprises a cover box in which functional components, such as the components in FIG. 1 are enclosed. The cover box provides power socket 156 through which electric power supply can be connected, signal socket 154 for receiving media content signals. The signal socket can be made in conforming any standard data transmission standards, such as IEEE RS232C and other standards derived therefrom, USB 1.0/2.0, fireware 1394, and other parallel or serial transmission standards. In other embodiments, wireless standards, such as IEEE 802.11b/g, can also be used. Button 160 is provided to enable the viewer to force the projection system to operate in enhanced mode or regular projection mode. Menu button 158 is provided to perform the system setting as described with reference to FIG. 5.

As an alternative feature, the projection system may have a wireless receiver married with a wireless transmitter so as to enable the viewer to wirelessly make the selection between the enhanced mode and regular mode, and wirelessly adjust the operations of the projection system.

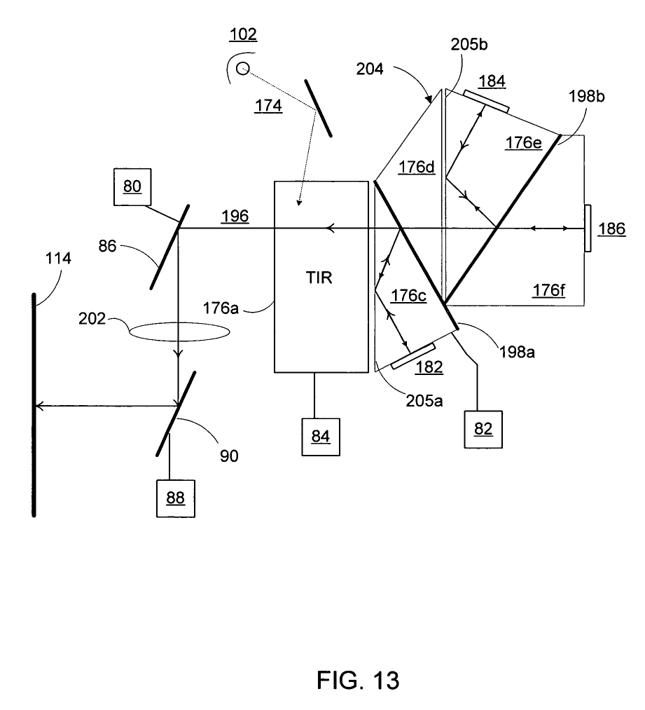

Other than the display system shown in FIG. 1, the projection system of FIG. 12 may enclose other projection systems having spatial light modulators, one of which is illustrated in FIG. 13. Referring to FIG. 13, the display system comprise uses a dichroic prism assembly 204 for splitting incident light into three primary color light beams. Dichroic prism assembly comprises TIR prisms 176a, 176c, 176d, 176e and 176f. Totally-internally-reflection (TIR) surfaces, i.e. TIR surfaces 205a and 205b, are defined at the prism surfaces that face air gaps. The surfaces 198a and 198b of prisms 176c and 176e are coated with dichroic films, yielding dichroic surfaces. In particular, dichroic surface 198a reflects green light and transmits other light. Dichroic surface 198b reflects red light and transmits other light. The three light valves, 182, 184 and 186, each having a micromirror array device, are arranged around the prism assembly.

In operation, incident white light 174 from light source 102 enters into TIR prisms 176a and is directed towards light valve 186, which is designated for modulating the blue light component of the incident white light. At the dichroic surface 198a, the green light component of the totally internally reflected light from TIR surface 205a is separated therefrom and reflected towards light valve 182, which is designated for modulating green light. As seen, the separated green light may experience TIR by TIR surface 205b in order to illuminate light valve 182 at a desired angle. This can be accomplished by arranging the incident angle of the separated green light onto TIR surface 205b larger than the critical TIR angle of TIR surface 205b. The rest of the light components, other than the green light, of the reflected light from the TIR surface 205a pass through dichroic surface 198a and are reflected at dichroic surface 198b. Because dichroic surface 198b is designated for reflecting red light component, the red light component of the incident light onto dichroic surface 198b is thus separated and reflected onto light valve 184, which is designated for modulating red light. Finally, the blue component of the white incident light (white light 174) reaches light valve 186 and is modulated thereby. By collaborating operations of the three light valves, red, green, and blue lights can be properly modulated. The modulated red, green, and blue lights are recollected and delivered onto display target 114 through optic elements, such as projection lens 202, if necessary.

In order to produce images and video signals with a higher perceived resolution than the total number of real physical pixels in each light valve (184, 186, and 182), the combined light 196 is further manipulated through mirror 86, mirror 90, and projection lens 202, wherein one or both of mirrors 86 and 90 are rotatable along axes passing their centers and pointing out from the paper. The rotations of mirrors 86 and 90 are driven by micro-actuators 80 and 88 that are respectively connected to the mirrors.

In the operation, the combined light 196 is reflected from mirror 86 towards mirror 90 through projection lens 202. The combined light after mirror 90 is reflected to display target 114 so as to generate the desired images and/or videos. By rotating mirror 86 or mirror 90, or both, the pixel patterns generated by the pixels of the light vales 182, 184, and 186 can be projected at different locations in the display target with the methods as discussed above with reference to FIG. 6 and FIG. 7. Alternative to rotating mirror 86 or mirror 90, TIR prism 176a can be moved, such as vertically or horizontally or rotating within or out of the paper or any combinations thereof, by micro-actuator 84 connected thereto so as to projecting the combined light 196 at different locations. In another embodiment, projection of the combined light 196 at different locations on the display target can be accomplished by moving the triangular prism having the TIR surface of 205 and to which light valve 182 is attached. Such movement can be accomplished through micro-actuator 82 attached to the triangular prism.

In commensurate with multi-mode operation, other elements of the projection system may be operated accordingly. For example, the illumination light output from illumination system 116 in FIG. 1 and FIG. 2 may have a brightness enhancing portion, as set forth in U.S. patent application Ser. No. 60/490,133 filed Jul. 25, 2003, Ser. No. 10/771,231 filed Feb. 4, 2004, Ser. No. 10/899,637 filed Jul. 26, 2004, and Ser. No. 10/899,635 filed Jul. 26, 2004, the subject matter of each being incorporated herein by reference. In the enhanced mode, such brightness enhancing portion may or may not be necessary.

In the enhanced and regular modes, media content can be projected with different aspect ratios, such as 16:9 or 4:3. The different aspect ratios can be accomplished by adjusting the total number of active pixels in the light valve, and/or by using a lightpipe, as set forth in U.S. patent application Ser. No. 60/620,395 filed Oct. 19, 2004, the subject matter being incorporated herein by reference.

In compliance with the regular and enhanced modes, the image data derived from the media content to be projected and/or the method of generating the image data may be different. For example, a frame of a video media content is often split into sequence of frames. In the enhanced mode, each frame may be divided into sub-frames; and the sub-frames during a frame period can be projected at different locations at the display target so as to obtain higher perceived image resolution.

For producing grayscales, a pulse-width-modulation technique can be employed; and a number of bitplanes representing the grayscales are derived from the media content to be projected based upon the pulse-width-modulation, as set forth in U.S. patent application Ser. No. 10/648,608 filed Aug. 25, 2004, the subject matter being incorporated herein by reference. Because the enhanced mode projects the media content at a different resolution than that projected in the regular mode, the total number of bitplanes, and/or the size of each bitplane may be different for the regular mode and enhanced mode. Specifically, the bitplane for the enhanced mode may have a larger size than the bitplane for the regular mode. Switches between different pulse-width-modulation sequencings can be associated with the selections of the regular mode and enhanced mode. For example, manually changing the regular and enhanced modes results in a change of the pulse-width-modulation sequencing.

It will be appreciated by those skilled in the art that a new and useful method of projecting an image using a light valve have been described herein. In view of the many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention.

We claim:

1. A projector comprising:
a light source;
a spatial light modulator upon which light from the light source is incident;
a projection optics for projecting an image from the spatial light modulator onto a display target;
an actuator attached to an element within the optical path of the light beam for increasing the resolution of the projected image by causing a sequence of images to be spatially offset from each other; and
a circuit in communication with the actuator for controlling the actuator for switching between a first viewing mode where the vibration mechanism is turned off and a second viewing mode where the vibration mechanism is turned on.

2. The system of claim 1, wherein the projector is a front projector.

3. The system of claim 1, further comprising: a button through which the operation mode is selected between the enhanced mode and regular mode.

4. The system of claim 1, further comprising:
a wireless receiver for receiving a selection between the enhanced mode and regular mode.

5. The system of claim 4, further comprising:
a wireless transmitter for transmitting the selection from a viewer.

6. The system of claim 1, further comprising:
a controller that comprises a selection module, said selection module is capable of automatically selecting a mode between the first and second viewing modes to project the image.

7. The system of claim 1, wherein the pixel array of the light valve comprises a sub-array; and wherein the pixel array is used in projecting the image in the first viewing mode, while the sub-array is used in projecting the image in the second viewing mode.

8. The system of claim 7, wherein the pixel array has a native aspect ratio of 4:3, and the sub-array has a native aspect ratio of 16:9.

9. The system of claim 7, wherein the pixel array has a native aspect ratio of 16:9, and the sub-array has a native aspect ratio of 4:3.

10. The system of claim 1, wherein the pixels of the light valve are reflective deflectable micromirror devices.

11. The system of claim 1, wherein the pixels of the light valve are LCD cells.

12. The system of claim 1, further comprising: a light source comprising an arc lamp.

13. The system of claim 1, wherein the light source comprises a LED.

14. The system of claim 10, wherein the micromirrors are square.

15. The system of claim 14, wherein the edges of the squared micromirrors are aligned in straight lines.

16. The system of claim 15, wherein the straight lines of the micromirror edges are parallel to the edges of the micromirror array.

17. The system of claim 15, wherein the straight lines of the micromirror edges are parallel to the edges of the light valve.

18. The system of claim 1, wherein the actuator comprises a vibrator.

19. The system of claim 18, wherein the vibrator is a piezoelectric device.

20. The system of claim 18, wherein the vibrator comprises:
a light transmissive solid state plate have first and second surface; and
first and second electrodes mounted on the first and second surfaces such that an optical refraction index of the plate varies under an electric field between the first and second electrodes.

21. A projector comprising an first viewing mode and a second viewing mode for optimizing the viewing experience, wherein an image produced by the system in the second viewing mode has a perceived resolution higher than a total number of pixels of a light valve used in projecting the image; and wherein the image produced by the system in the first viewing mode has a perceived resolution equal to or less than the total number of pixels of the light valve used in producing the image.

22. The projector of claim 21, wherein the projector is a front projector.

23. The projector of claim 21, wherein the light valve comprises a sub-array within an array of pixels of the light valve; and wherein the array is used for projecting the image in then first mode, while the sub-array is used for projecting the image in the second mode.

24. The projector of claim 23, wherein the array comprises 1024×768 pixels.

25. The projector of claim 24, wherein the sub-array comprises 1024×576 pixels.

26. The projector of claim 23, wherein the array comprises 1340×780 pixels.

27. The projector of claim 26, wherein the sub-array comprises 1280×768 pixels.

28. The projector of claim 21, further comprising:
an actuator mechanism attached to an element of the projector such that by a reflected light from one pixel of the light valve at an ON state is projected on a set of different locations on a display target.

29. The projector of claim 28, wherein the element is a mirror plate; and wherein the actuator mechanism is a micro-actuator.

30. The projector of claim 21, further comprising:
a control mechanism enabling a viewer to select between the first and second modes, wherein the controller further comprises:
a button by acting which the projector is forced to be operated in a mode selected by the viewer.

31. The projector of claim 30, wherein the controller further comprises:
a menu comprises a first selection such that by making the first selection, the projector automatically selects between the first mode and second mode.

32. The projector of claim 31, wherein the first selection further comprises a first sub-selection such that by making the first sub-selection, the projector automatically detects a property of the image and selects between the first and second modes based on the property.

33. The projector of claim 31, wherein the first selection further comprises a second sub-selection such that by making the second sub-selection, the projector samples the image to be projected and selects between the first and second mode based on the sampled image.

34. A method of projecting an image content using a light valve having an array of pixels, comprising:
selecting a projection mode between a first mode and a second mode, wherein the image content produced in the first mode has a perceived resolution higher than a total number of pixels of the light valve; and wherein the image content produced in the second mode has a perceived resolution equal to or less than the total number of pixels of the light valve used in producing the image; and
projecting the image with the selected mode.

35. The method of claim 34, wherein the step of selecting the projection mode further comprises:
manually causing the system to operate in the first mode or the second mode.

36. The method of claim 34, wherein the step of selecting the projection mode comprises:
selecting the projection mode based on a property of the image content.

37. The method of claim 36, further comprising:
determining the property of the image content; and
selecting the second mode when the image content is substantially static.

38. The method of claim 37, wherein the step of determining the property further comprises:
extracting a parameter from the image content, which characterizes the property of the image, further comprising:
determining the property of the image content; and
selecting the enhanced mode when the image content is substantially animated.

39. The method of claim 38, wherein the step of determining the property further comprises:
extracting a parameter from the image content, which characterizes the property of the image content.

40. The method of claim 36, further comprising:
sampling the image content;
projecting the sample using one of the first mode and the second mode;
evaluating a quality of the projected sample; and
selecting the projection mode based on the evaluated quality.

41. The method of claim 40, wherein the step of selecting the projection mode further comprising:
if the evaluated quality is above a threshold, selecting the projection mode in which the sample is projected; and
selecting the other projection mode is the evaluated quality is lower than the threshold.

42. The method of claim 36, further comprising:
sampling the image content;
projecting the sample using both of the enhanced mode and regular mode;
comparing a quality of the projected samples with the enhanced mode and regular mode; and
selecting the projection mode based on the comparison.

43. The method of claim 36, further comprising:
empirically selecting the projection mode based upon a viewer's historical viewing selection.

44. The method of claim 34, wherein the step of projecting the image with the selected mode further comprises:
actuating an element of the projector such that a light beam reflected from a pixel at an ON state of the light valve is projected at a set of different locations at the display target.

45. The method of claim 34, wherein the step of projecting the image with the selected mode further comprises:
actuating an element of the projector such that a sequence of images of the image content is spatially offset from each other.

46. A projector comprising:
first means for selecting a projection mode between a first mode and a second mode, wherein the image content produced in the first mode has a perceived resolution higher than a total number of pixels of the light valve; and wherein the image content produced in the second mode has a perceived resolution equal to or less than the total number of pixels of the light valve used in producing the image; and
second means for projecting the image with the selected mode.

47. The projector of claim 46, wherein the second means further comprises:
third means for vibrating an element of the projector such that a sequence of images of the image content is spatially offset from each other.

48. The projector of claim 46, further comprising:
fourth means for enabling a viewer to select between the first and second mode.

49. The projector of claim 48, wherein the fourth means further comprises:
fifth means for forcing the projector to be operated in the first mode or the second mode.

50. A computer readable medium having computer executable instructions to perform the method of claim 34.

51. A projector, comprising:
a spatial light modulator having an array of pixels each having a set of edges;
first means for selecting a projection mode between first and second modes, wherein the pixel edges have substantially different viewing effects when projected in the first and second modes; and
second means for projecting the image based on the selected mode.

52. The projector of claim 51, wherein the pixel edges are visible at a display target when projected in the first mode; while not visible in the second mode.

53. The projector of claim 52, wherein the second means comprises an illumination system for producing illumination light for the projector.

54. A projector, comprising:
a light valve having an array of pixels;
first means for producing an image of the light valve pixel at a display target; and
second means for selecting a projection mode between first and second modes, wherein the image of the light valve pixel is at a first location on the display target in the first mode; while the image pixel is at a second location on the display target in the second mode for at least a period of time during the first mode.

55. The projector of claim 54, wherein a reflected light beam from the light valve pixel at the ON state propagates along first and second paths in the first mode.

56. The projector of claim 54, wherein the first means comprises:
an element other than the light valve pixels at a propagation path of an illumination light for altering a propagation path of the illumination light.

57. The projector of claim 56, wherein the illumination light is reflected light from a light valve pixel.

58. The projector of claim 57, wherein the element is a reflective mirror.

59. The projector of claim 57, wherein the element is a solid state material through which the illumination light passes and alters the propagation path.

60. A projector, comprising:
a light valve having an array of pixels for reflecting a light beam;
first means other than the light valve pixels for causing the reflected light beam to oscillate between multiple propagation paths in a first viewing mode and to constantly propagate along one of the multiple propagation paths in a second mode; and
second means for selecting between the first and second modes.

61. A projector for producing an image, comprising:
a sequencer that derives a first sequence of bitplanes in a first mode and a second sequence of bitplanes substantially different from the first sequence in a second mode;
a light valve having an array of pixels for modulating a light beam using the bitplanes of from the first or the second sequence; and
means for projecting the modulated light so as to produce the image.

62. The projector of claim 61, wherein the bitplanes are compliance with a binary weighted pulse-width-modulation.

63. The projector of claim 62, wherein the first sequence of bitplanes has a larger number than that of the second sequence of bitplanes.

64. The projector of claim 62, wherein the light beam modulated by a light valve pixel at an ON state in the first mode is projected at a multiplicity of locations at a display target.

65. The projector of claim 62, further comprising:
means for selecting between the first and second modes.

66. The projector of claim 65, wherein the means for selecting further comprises:
means for manually selecting between the first and second modes.

67. A projector, comprising:
a light valve having an array of pixels for modulating a light beam;
means for selecting between first and second modes, wherein an optical path of the modulated light beam in the first mode has at least a portion of which during a particular period of time is different than in the second mode; and
means for projecting the modulated light so as to produce a visible image.

68. The projector of claim 67, wherein the means for projecting the modulated light comprises:
means for oscillating the propagation path of the light beam between multiple propagation paths in the first mode.

69. A projector, comprising:
a light valve having an array of pixels for producing an array of image pixels on a display target by modulating a light beam;
means for selecting between first and second mode, wherein the image pixels are displaced from ⅛ to ⅞ of a characteristic length of the pixel in the first mode in relation to the image pixels in the second mode; and
means for producing the image pixels according to an image.

70. The projector of claim 69, wherein the characteristic length is a diagonal or length of one of the light valve pixels.

71. The projector of claim 70, wherein the image pixels in the second mode has a geometric center that is substantially constant in the second mode; and wherein the geometric center of the image pixels oscillates between a multiplicity of locations.

72. The projector of claim 70, wherein the displacement is from ¼ to ¾.

73. The projector of claim 70, wherein the displacement is approximately ½.

74. A projector comprising:
a light source;
a spatial light modulator upon which light from the light source is incident;
a projection optics for projecting an image from the spatial light modulator onto a display target;
an actuator attached to the spatial light modulator or a lens or a mirror at the optical path of the light beam for increasing the resolution of the projected image by causing a sequence of images to be spatially offset from each other, wherein the actuator comprises a piezoelectric device or a light transmissive plate having first and second electrodes formed on for varying an optical refractive index of the plate; and
a circuit in communication with the actuator for controlling the actuator for switching between a first viewing mode where the vibration mechanism is turned off and a second viewing mode where the vibration mechanism is turned on.
